(19) United States
(12) Patent Application Publication
(10) Pub. No.: US 2003/0154426 A1
(43) Pub. Date: Aug. 14, 2003

(54) Method and apparatus for programmable BIST and an optional error counter

(76) Inventors: David Chow, Los Altos, CA (US); Jan Frode Loennum, Jonsvatnet (NO)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/074,506

(22) Filed: Feb. 11, 2002

(51) Int. Cl. G06F 11/27

(52) U.S. Cl. 714/30

(57) ABSTRACT

Hardware or software to test a memory device by loading a value into a register and generating a test sequence in response to the value. Storing a signature of the result of the test sequence in a shift register. An optional error counter to detect the location and type of defect.

### FIELD OF THE INVENTION

The present invention relates to test, and specifically to a method and apparatus for self-test within an integrated device utilizing programmable built-in test patterns.

### DESCRIPTION OF THE RELATED ART

As the technology for manufacturing integrated circuits advances, more logic functions are included in a single integrated circuit device. Modern integrated circuit (IC) devices include large numbers of gates on a single semiconductor chip, with these gates interconnected so as to perform multiple and complex functions. The manufacture of such circuits incorporating such Very Large Scale Integration (VLSI) requires that the fabrication of the circuit be error free, as some manufacturing defects may prevent it from performing all of the functions that it is designed to perform. This requires verification of the design of the circuit and also various types of electrical testing after the IC is manufactured.

However, as the complexity of the circuit increases, so does the cost and difficulty of verifying and electrically testing each of the devices in the circuit. Electrical testing requires that each gate in a VLSI circuit functions properly. Therefore, each gate needs to individually and in conjunction with the other gates in the circuit function properly in all possible combinations of operations. Typically, electrical testing is performed by automated testing equipment (ATE) that employs test vectors to perform the desired tests. A test vector describes the desired test input (or signals), associated clock pulse (or pulses), and expected test output (or signals) for every package pin during a period of time, often in an attempt to “test” every node of each gate. For complex circuitry, this may involve a large number of test vectors and accordingly a long test time.

One way to address this problem is through design for test (DFT). One typical DFT method is Built in Self Test (BIST). An integrated device may have dedicated logic to receive external test patterns. The device stores the external test pattern. Then, it applies the test pattern to the device and determines whether an error has occurred based on expected results. However, in order to increase fault coverage, a large number of test patterns are needed to be stored in the integrated device. The size of the integrated device increases to accommodate the test patterns which results in increased manufacturing costs.

### BRIEF DESCRIPTION OF THE SEVERAL VIEWS OF THE DRAWINGS

The present invention is illustrated by way of example and not limitation in the following figures. Like references indicate similar elements, in which:

FIG. 1 illustrates a plurality of bit values of a register for memory tests utilized by an embodiment.

FIG. 2 illustrates a typical prior art shift register utilized by an embodiment.

FIG. 3 illustrates a truth table for data patterns with reference to address bits utilized by an embodiment.

### DETAILED DESCRIPTION OF THE INVENTION

A method and apparatus for efficient memory test and programmable built in self-test within an integrated device are described. In the following description, for purposes of explanation, numerous details are set forth in order to provide a thorough understanding of the present invention. However, it will be apparent to one skilled in the art that these specific details are not required in order to practice the present invention.

An area of current technological development relates to achieving increased fault coverage for testing of memory devices by utilizing design for test concepts. As previously described, BIST allows for efficient memory testing. However, such an approach may be inflexible or inefficient. For example, a large number of memory test patterns are required to ensure proper functionality of the memory device. However, the large number of test patterns result in significant increase in the size of the integrated device to accommodate the memory test patterns. Thus, implementing a more efficient method of generating programmable BIST patterns without the need for storing the memory patterns is desirable.

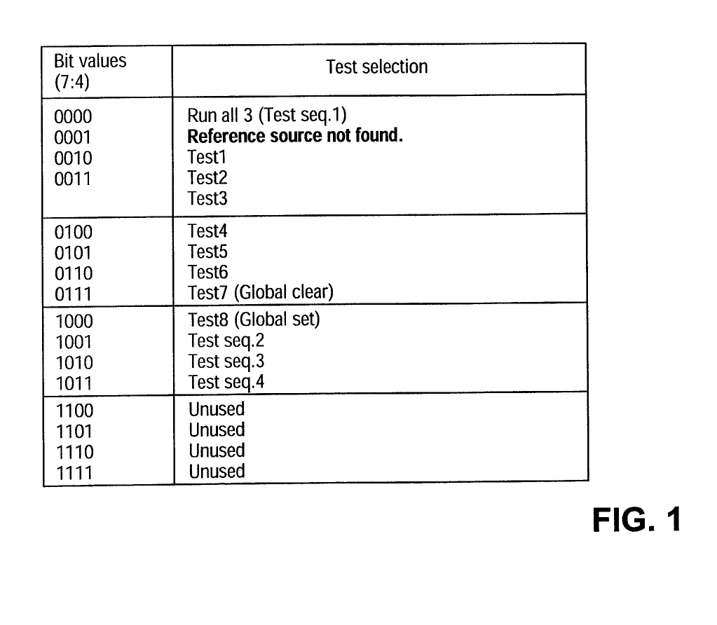

FIG. 1 illustrates a plurality of bit values of a register for memory tests utilized by an embodiment of the present invention. The diagram indicates a bit value to correspond to a test or test sequence. Each test and test sequence will be discussed in detail in the following paragraphs. Also, a few bit values are unused and are reserved for future use to accommodate more memory test patterns or other functional purposes.

In one aspect, the claimed subject matter supports programmable BIST by setting a four bit value in a register and generating a test pattern with reference to the bit value. In another aspect, the claimed subject matter allows for grouping of test patterns into a test sequence resulting in efficient test time. Specifically, a test sequence is a program that calls up predefined test patterns that perform a particular test/fault coverage function. By ordering the test patterns for a specified test sequence, the claimed subject matter allows for detection of various types of faults that can occur in memories. Therefore, minimizing design area and logic for storing and running the test patterns. In yet another aspect, the claimed subject matter allows for a specific memory test pattern to be generated, rather than an entire test sequence. Another aspect supports a unique combination of test patterns and test sequences to efficiently detect an error. In still yet another aspect, the claimed subject matter describes an optional error counter to detect and locate the location and type of errors.

The first four bit value of “0000” instructs a memory device to generated a test sequence #1 comprising an order of Test #1, Test #2, and finally Test #3. In one embodiment, the memory device is a polymer memory and during a self-test mode of operation a 256 bit data word.

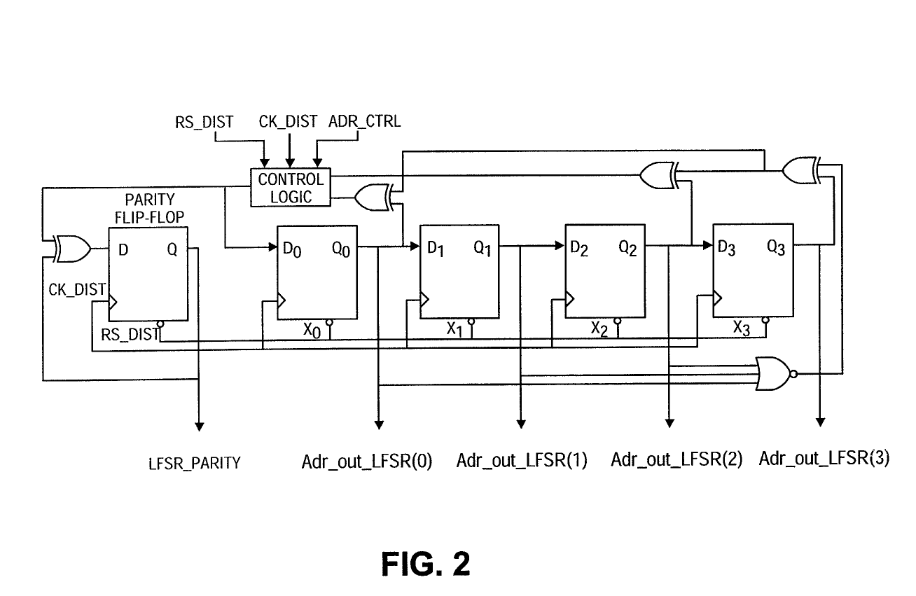

The Test #1 performs a write operation of a binary one value to the array. Subsequently, a read operation, starting at address 0000h is performed for all the memory locations. Finally, the data is feed into the shift register depicted in FIG. 2 to generate a signature.

The Test #2 performs a read operation of all the addresses in increasing order starting at address 0000h. Subsequently, the data is feed into the shift register depicted in FIG. 2 to generate a signature.

The Test #3 performs a write operation of an even test pattern starting with address 0000h. While increasing the address, the test #3 continues to write an even test pattern for the entire wordline row. However, test #3 performs a write operation of an odd test pattern (to the successive wordline. This pattern of alternating even and odd test patterns is continued. Finally, a read operation starting with address 00000h will result in feeding the data into a shift register to generate a signature.

The claimed subject matter supports running a individual test or a subset of a test sequence. For example, the testing of a memory could use either Test #1, or both Test #2 and Test #3 by setting the bit values to “0010” or “0011”, respectively.

A four bit value of “1001” instructs a memory device to generated a test sequence #2 comprising an order of Test #4, Test #5, and finally Test #7.

The Test #4 performs a read operation in decreasing order starting at the last address of the addressing sequence used in Test #2. Subsequently, the data is feed into the shift register depicted in FIG. 2 to generate a signature.

The Test #5 performs a read operation of address 00000h followed by a write operation of binary logic one values to the same address. This reiterative process is repeated for all the addresses. Subsequently, the data is feed into the shift register depicted in FIG. 2 to generate a signature. After Test #5, the entire array contains logic one values.

The Test #7 performs a read operation of all addresses in increasing order starting at address 00000h.

A four bit value of “1010” instructs a memory device to generated a test sequence #3 comprising an order of Test #7, Test #5, Test #4 and finally Test #2. The tests #2,4,5, and 7 were discussed in the preceding paragraphs. Subsequently, the data is feed into the shift register depicted in FIG. 2 to generate a signature.

A four bit value of “1011” instructs a memory device to generated a test sequence #4 comprising an order of Test #7, Test #5, Test #2, Test #6, Test #4, and finally Test #2. The tests #2,4,5, and 7 were discussed in the preceding paragraphs.

Test #6 is similar to Test #5 except the start address is the last address that performed a read and write operation. Subsequently, the data from the resulting read operations is input into the shift register depicted in FIG. 2 to generate a signature.

A four bit value of “1000” instructs a memory device to generate a test pattern #8. In one embodiment, the test pattern #8 is a global set and performs a write operation of a binary one value in all addresses in increasing order starting at a first address of 00000h.

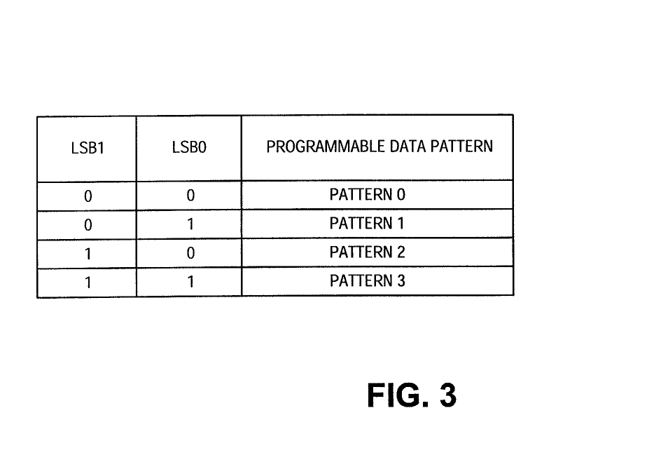

FIG. 3 illustrates a truth table for data patterns based on address bits utilized by an embodiment. The truth table represents an embodiment for selecting data patterns based on the least significant bits of the address of the memory to be used by an error counter. An integrated device that incorporates memory could utilize the programmable bist patterns previously discussed, with the addition of an error counter. Alternatively, an integrated device may utilize other memory test patterns, rather than the programmable bist patterns, with the error counter.

In one embodiment, the memory array of the integrated device performs a write operation based on programmable input data based on the address bits. For example, odd addresses of the memory array are written with a data pattern of “01100110” binary, while the even addresses are written with the complement data pattern of“10011001”. In another embodiment, the input data is based on the least significant bit or bits of the address, which is depicted in FIG. 3. The columns 302 indicate the two least significant bits of the address of the memory, LSB0 and LSB1. The column 304 indicates the data pattern. In one embodiment, the data patterns are programmed by the user (test engineer, external test host, or test equipment) via a programmable register and loaded into a plurality of chip test data registers, wherein both the programmable register and plurality of data registers are internal to the integrated memory device. In one embodiment, the chip test data registers are designated as 0, 1, 2, and 3.

Although the scope of the claimed subject matter is not limited in this respect, it is noted that the programmable register discussed in the preceding paragraph may be incorporated from the following filed application: United States application Ser. No. of ______, and titled “A Method and Apparatus to Enhance Testability and Validation of a Memory Device”, by David Chow, attorney docket number P11251.

After the data patterns are user programmed, the memory array is read out using any of the typical memory patterns to detect faults in the memory array. In one embodiment, the memory test pattern applied is based at least in part on the type of manufacturing fault that the memory test pattern is designed to detect.

After the data is read out of the memory array, it is logically compared via at least one EXOR gate to the corresponding chip test data register based at least in part on the address. Thus, the data written to an address is dependent on the address, and allows for a subsequent decoding of the type of input write data on the read operation.

Based on the output of the EXOR logic and an error counter, the number of mismatch bits can be determined by comparing the data read out of the memory array with the corresponding chip test data register and keeping a tally of the number of mismatch bits with the error counter.

The error counter can be implemented in a multitude of schemes. For example, a shift register may be implemented because the operating frequency of the CMOS logic is faster than the memory array's read latency. In another example, any custom logic may be implemented for the error counter.

The number of mismatch bits is added to the ERROR_COUNTER total and is reset to zero at the beginning of a BIST test or memory pattern. Eventually, at the completion of a memory pattern or BIST test pattern for the entire memory array, the user may read out the ERROR_COUNTER to determine the number of errors that have been detected.

The preceding discussion of the ERROR_Counter was to calculate the number of errors. The following paragraphs depict a variety of schemes to allow the user a more detailed and granular analysis.

For example, one scheme incorporates an embodiment where the ERROR_Counter may be utilized to analyze distribution of errors. First, the user sets a threshold for a number of errors for a specific address. In one embodiment, there is 256 data bits per address and the user may set a threshold of 50 bits. If the number of mismatched bits (errors) exceeds the user set threshold of 50, a ERROR_THRESHOLD_COUNTER(s) is incremented by 1. Thus, at the end of the memory test or BIST pattern, the distribution of errors based on the threshold counter for each address is readily available for analysis. In an alternative embodiment, multiple threshold counters with different threshold settings are utilized to give a relative error rate for the same memory or BIST pattern.

In another scheme, an embodiment is utilized where the BIST or memory pattern is configured with a starting address and an ending address. Thus, the user has the flexibility to test and calculate errors (error map) for a subset of memory addresses. The preceding scheme offers the advantage of reducing test time and concentrating on a subset of addresses.

In yet another scheme, the number of mismatched bits (errors) is categorized based on the location of failure within the word. In one embodiment, the number of data bits per address is a 256 bit word and the granularity may be 64 bits. Thus, four error column counters (0,1,2, and 3) are implemented to count the number of mismatched bits (errors) for their respective range within the 256 word because four counters are needed since the word is 256 bits and the granularity is 64 bits, (256 divided by 64). Specifically, Column counter 0 detects errors for bits 0:63 of the word, Column counter 1 detects errors for bits 64:127 of the word, Column counter 2 detects errors for bits 128:191 of the word, and Column counter 3 detects errors for bits 192:255) of the word. The granularity scheme allows the user more resolution to detect the source of the error, such as a physical defect, with more precision within the word. One skilled in the art appreciates utilizing more than four column counters per word to achieve more resolution to detect the physical defect of the error.

In yet another scheme, the granularity is on a per address test basis. In one embodiment, three counters are utilized with the following designation Error_Single_Address_Counters(0,1,2). The counters are reset before the execution of the BIST or memory pattern. Subsequently, a user programmed number of write and read operations are performed utilizing data from a pseudo random number generator. The write and read operations are for a single address that is defined in a configuration register. Upon the completion of the BIST or memory pattern, each counter may be designated to represent different defect types and/or good bits that have been detected as a result of the completion of the BIST or memory pattern. After the completion of the BIST or memory pattern, the data read out of the memory is logically compared via EXOR logic to the expect data generated by the pseudo random number generator. A logical AND operation is performed on the result of the logical EXOR comparison, EXOR_CMP, to the expect data. The result of the preceding AND operation is stored in counter 2. The EXOR_CMP is logically ANDed with the read data from the array and stored in counter 1. Finally, the inverse of EXPR_CMP is stored in counter 0. Thus, the value of counter 2 may represent the number of stuck at one faults, the value of counter 1 may represent the number of stuck at zero faults, and the value of counter 0 may represent the number of good bits.

While the invention has been described with reference to specific modes and embodiments, for ease of explanation and understanding, those skilled in the art will appreciate that the invention is not necessarily limited to the particular features shown herein, and that the invention may be practiced in a variety of ways that fall under the scope and spirit of this disclosure. The invention is, therefore, to be afforded the fullest allowable scope of the claims that follow.

1. A method comprising:
loading a value into a register of a memory device;
generating a test sequence in response to the value in the register during a self-test mode of operation of the memory device;
testing the memory device with the test sequence; and
storing a signature as a result of the test sequence into a shift register.

2. The method of claim 1 wherein the value is a four bit field.

3. The method of claim 1 wherein the memory device is a polymer memory organized as a 8K by 8K array with a 256 bit data word during the self-test mode of operation.

4. The method of claim 1 wherein the test sequence is one of a test pattern or a plurality of test patterns.

5. An article comprising:
a storage medium having a plurality of machine readable instructions, wherein when the instructions are executed by a memory device, the instructions provide to:
load a value into a register of the memory device;
generate a test sequence in response to the value in the register during a self-test mode of operation of the memory device;
test the memory device with the test sequence; store a signature as a result of the test sequence into a shift register.

6. The article of claim 5 wherein the value is a four bit field.

7. The article of claim 5 wherein the memory device is a polymer memory organized as a 8K by 8K array with a 256 bit data word during the self-test mode of operation.

8. The article of claim 5 wherein the test sequence is one of a test pattern or a plurality of test patterns.

9. An apparatus to test a memory device comprising:
a register integrated within the memory device to load a value;
a logic to generate a test sequence in response to the value during a self-test mode of operation of the memory device and to test the memory device with the test sequence;
a shift register to store a signature as a result of the test sequence; and
an error counter to tabulate the number of errors as the result of the test sequence.

10. The apparatus of claim 9 wherein the value is a four bit field.

11. The apparatus of claim 9 wherein the memory device is a polymer memory organized as a 8K by 8K array with a 256 bit data word during the self-test mode of operation.

12. The apparatus of claim 9 wherein the test sequence is one of a test pattern or a plurality of test patterns.

13. The apparatus of claim 9 wherein the error counter utilizes a shift register to tabulate the number of errors.

14. A memory device comprising:
a logic to support programmable built-in self-test (BIST) patterns; and
an error counter to tabulate a number of errors detected as a result of at least one BIST pattern applied to the memory device.

15. The memory device of claim 14 further comprising a plurality of programmable input data to test the memory device.

16. The memory device of claim 14 wherein at least one BIST pattern is to be generated by a data pattern stored in a chip test data register based at least in part on an address of the memory.

17. The memory device of claim 14 wherein the error counter is reset to zero before the BIST pattern is applied to the memory device.

18. The memory device of claim 14 wherein the error counter is incremented if the errors exceed a programmable threshold for an address of the memory device.

19. The memory device of claim 14 wherein the error counter is to count errors for a subset of the memory device, defined by a starting address and an ending address.

20. The memory device of claim 14 wherein the error counter is to count errors for a subset of a word, which represents a number of bits in an address.

21. The memory device of claim 14 wherein the error counter is a plurality of registers, the registers to store a count for at least one defect type and to store a count of the number of good bits for an address of the memory device.

22. The memory device of claim 21 wherein the defect type is either one of a stuck at one fault or a stuck at zero fault.
